(19) United States
(12) Patent Application Publication
(10) Pub. No.: US 2018/0188902 A1
(43) Pub. Date: Jul. 5, 2018

(54) SYSTEM AND METHOD FOR DIGITAL TELEVISION OPERATION AND CONTROL INTERFACE PRESENTATION - Search

(71) Applicants: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(72) Inventors: Sanjiv SIRPAL, Oakville (CA); Mohammed SELIM, Oakville (CA); Alexander DePaz, Burlington (CA); Salvador SOTO, Toronto (CA); Saulo Correia DOURADO, Oakville (CA); Robert MacArthur, Milton (CA); Dean BRITTO, Mississauga (CA)

(73) Assignees: Jamdeo Canada Ltd., Oakville (CA); Hisense Electric Co., Ltd., Qingdao (CN); Hisense USA CORP., Suwanee, GA (US); Hisense International Co., Ltd., Qingdao (CN)

(21) Appl. No.: 15/396,034

(22) Filed: Dec. 30, 2016

(51) Int. Cl. G06F 3/0482; G06F 3/0481; G06F 3/0485

(52) U.S. Cl. CPC G06F 3/0482; G06F 3/0485; G06F 3/04817

(57) ABSTRACT

The present disclosure relates to digital television processes and systems. In one embodiment, a method for display device operation including presentation of a control interface search component includes presenting a control interface according to a spatial arrangement model and including interface components, wherein the control interface is presented to include graphical presentations of a launcher component, dashboard component and activity strip according to display positions and formats of the spatial arrangement model, and a graphical search element indicating a search component of the control interface. The method also includes detecting a directional command associated with the display position of the graphical search element and updating presentation of the control interface to present a graphical representation of the search component, the search component providing an interface and search function for each of the launcher component, dashboard component and activity strip.

### FIELD

The present disclosure relates to electronic devices and applications, and more particularly to display and content presentation devices.

### BACKGROUND

Recent television devices are designed and developed to provide application and network services in addition to traditional television functions for display of broadcasted content. With the addition of functionalities and components on television devices, there exists a need for control interfaces for applications and television components. In particular, there exists a need for programs and configurations that allow for features of the applications to be presented, accessed and customized on a digital television. While execution of an application and application interfaces exist for digital televisions, there exists a need for improved control of television features. It can be difficult for device manufactures to provide menu based configurations that fit all devices across different product markets. Moreover, there exists a desire for interfaces to be customizable. Conventional on-screen interfaces do not allow for customization. Moreover, the conventional interfaces require complex menus with distracting elements and can require extraneous actions for use. There is a desire for modified configurations to optimize control and experience of digital televisions.

### BRIEF SUMMARY OF THE EMBODIMENTS

Disclosed and claimed herein are methods, devices and systems for control of a digital television. One embodiment is directed to a method for display device operation including presentation of a control interface search component. The method includes presenting, by the display device, a control interface according to a spatial arrangement model and including interface components. The control interface is presented to include graphical presentations of a launcher component, dashboard component and activity strip according to display positions and formats of the spatial arrangement model, and a graphical search element indicating a search component of the control interface. The method also includes detecting, by the display device, a directional command associated with the display position of the graphical search element. The method also includes updating, by the display device, presentation of the control interface to present a graphical representation of the search component, the search component providing an interface and search function for each of the launcher component, dashboard component and activity strip.

In one embodiment, the spatial arrangement model defines the arrangement of each of the launcher component, dashboard component, activity strip and graphical search element.

In one embodiment, the spatial arrangement model includes a cross shape layout wherein each of the launcher component, dashboard component activity strip and graphical search element are positioned at a terminus of the cross shape layout.

In one embodiment, the graphical search element is positioned in a top portion of the control interface, and wherein the directional command associated with the display position of the graphical element indicating a search component is an up command.

In one embodiment, the control interface includes a graphical presentation of a launcher component, the launcher component configured for selection and presentation of content, a graphical presentation of a dashboard component, the dashboard component configured to present a personalized interface based on a user profile, and a graphical presentation of an activity strip, the activity strip configured to present a plurality of tile elements for selected content.

In one embodiment, updating presentation of the control interface to present the graphical representation of the search component includes transition of the graphical search element from a top position by way of a drop down animation and presentation of graphical elements of the search component.

In one embodiment, updating presentation of the control interface to present the graphical representation of the search component includes display of a character input display, search entry, and listing of recent searches.

In one embodiment, presentation of the search component includes display of an optical target to provide a secondary device with a temporary connection to the display device.

In one embodiment, the method also includes generating a temporary network control interface based on detection of scanning of the optical target by the secondary device, wherein the search component is provided to the secondary device by way of the temporary network control interface.

In one embodiment, the search component searches control interface components based on one or more of content, applications and titles of the components.

Another embodiment is directed to a digital television including a display configured to present a control interface a processor coupled to the display. The processor is configured to present a control interface according to a spatial arrangement model and including interface components. The control interface is presented to include graphical presentations of a launcher component, dashboard component and activity strip according to display positions and formats of the spatial arrangement model, and a graphical search element indicating a search component of the control interface. The processor is configured to detect a directional command associated with the display position of the graphical search element, and update presentation of the control interface to present a graphical representation of the search component, the search component providing an interface and search function for each of the launcher component, dashboard component and activity strip.

Other aspects, features, and techniques will be apparent to one skilled in the relevant art in view of the following detailed description of the embodiments.

### BRIEF DESCRIPTION OF THE DRAWINGS

The features, objects, and advantages of the present disclosure will become more apparent from the detailed description set forth below when taken in conjunction with the drawings in which like reference characters identify correspondingly throughout and wherein:

FIG. 1 depicts a graphical representation of a control interface of a display device according to one or more embodiments;

FIG. 2 depicts a simplified system diagram according to one or more embodiments;

FIG. 3 depicts a process for device operation including presentation of a control interface according to one or more other embodiments;

FIG. 4 depicts a process for presentation of a search component control interface according to one or more embodiments;

FIG. 5A depicts a graphical representation of control interface components and a spatial arrangement model according to one or more embodiments;

FIG. 5B-5C depicts graphical representations of control interface display formats according to one or more embodiments;

FIGS. 6A-6B depicts a graphical representation of search component control interface components and presentation according to one or more embodiments;

FIG. 7 depicts a graphical representation of a search component operation according to one or more embodiments; and

FIG. 8 depicts a process for search component operation according to one or more embodiments.

### DETAILED DESCRIPTION OF THE EXEMPLARY EMBODIMENTS

### Overview and Terminology

One aspect of the disclosure relates to providing a control interface for a digital television. In one embodiment, a system and framework are provided for presentation of a control interface according to a spatial arrangement model and including interface components. Components of the control interface include a graphical presentation of a launcher component configured for selection and presentation of content, a graphical presentation of a dashboard component configured to present a personalized interface based on a user profile, and a graphical presentation of an activity strip configured to present a plurality of tile elements for selected content.

Another aspect is directed to presenting a multiple layered approach to presentation of a user interface having multiple display formats relative to a highlight or selection element of the control interface. By way of example, the control interface can allow for navigation and modification of a component while still allowing for minimal navigation inputs to select and navigate within the display format of another control interface component. Providing multiple levels for each format allows for a visual control interface that can be operated from a distance without touch commands, the use of a mobile application and allows for control with a remote device having a directional pad. Another aspect is directed to personalization of a control interface, and in particular control interface operation to access and utilize the personal dashboard. In one embodiment, features of the control interface may be modified or personalized. In additional the control interface may store and allow for operation of a plurality of user profiles/personal control interfaces.

As used herein, the terms “a” or “an” shall mean one or more than one. The term “plurality” shall mean two or more than two. The term “another” is defined as a second or more. The terms “including” and/or “having” are open ended (e.g., comprising). The term “or” as used herein is to be interpreted as inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

Reference throughout this document to “one embodiment,” “certain embodiments,” “an embodiment,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics may be combined in any suitable manner on one or more embodiments without limitation.

### Exemplary Embodiments

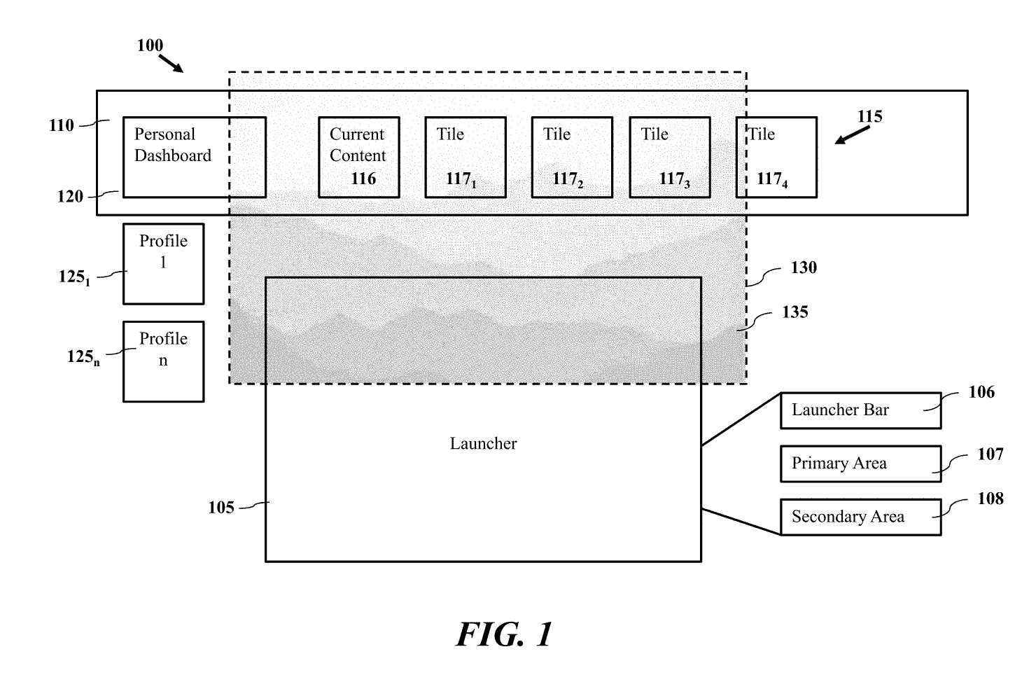

Referring now to the figures, FIG. 1 depicts a graphical representation of a control interface of a display device according to one or more embodiments. According to one embodiment, control interface 100 relates to a graphical user interface presented to control a display device, such as a digital television. According to one aspect of the disclosure, control interface 100 includes a plurality of components that each provide a plurality of functions and features for control and operation of a display device. In addition to providing separate components for particular interaction, control interface may also be configured to operate with a specific arrangement. According to one embodiment, presentation of each component of control interface 100 is presented based on a spatial arrangement model. According to one embodiment, the spatial arrangement model defines a relative position of components of control interface 100 to allow for directional navigation of the interface. By employing a spatial arrangement model, components of the control interface 100 allow for many features of the display device to be easily accessed and controlled. In addition to facilitating access, the spatial arrangement model provides a specific formatting to each view of control interface to emphasize elements for control.

According to one embodiment, components of control interface 100 include launcher component 105, dashboard component (e.g., personal dashboard) 110 and activity strip 115. According to another embodiment, a spatial arrangement model defines the location of each component of control interface 100 relative to a display screen. In an exemplary embodiment, launcher component 105 is oriented relative to a bottom portion of the display, dashboard component (e.g., personal dashboard) 110 is oriented relative to a left side of the display, and activity strip 115 is oriented relative a right side of the display. According to another embodiment, the display format of each component is defined by the spatial arrangement model such that each component may have an initial presentation characterized by a particular format, size, functionalities displayed, etc. Based on navigation commands relative to the control interface, the display device may update and rearrange the position and display format for each component of control interface 100.

Control interface 100 is shown in FIG. 1 relative to a display 130 and display content 135. According to one embodiment, the display format of control interface 100 can include presentation of some or all components of the control interface on display 130. Based on commands detected during presentation of the control interface 100, a display device may update the presentation format and elements of control interface 100 on display 130.

According to one embodiment, control interface 100 provides a mechanism for accessing multiple components of a display device. While the description of FIG. 1 discusses three components of control interface 100 (launcher component 105, dashboard component 110 and activity strip 115), it should be appreciated that additional components may be added to or included with control interface 100. As will be discussed herein, control interface 120 may be employed to control operation of digital television.

Activity bar includes plurality of tile elements 116 and 117₁₋ₙ. According to one embodiment, presentation of control interface 100 may be presented as an overlay to content 135 presented on display 130. The display device may freeze or continue presenting the display output of content 135 in a tile element 116 in activity bar 115. In certain embodiments, navigation away from current content tile 116 will pause or stop playback. Current content tile 116 allows for selection of the previously displayed content to return to presentation of the display. Current content tile 116 is presented based on the content displayed by the display device prior to display of control interface 100. Tile elements 117₁₋ₙ relate to activity feed based on current content. In one embodiment, tile elements 117₁₋ₙ relate to a single type of content, such as broadcast TV shows related current content 116 and/or based on viewing habits of an active profile. According to another embodiment, tile elements 117₁₋ₙ may be a mix of content types, such as broadcast content, video on demand, applications, etc. In one embodiment, a display device may curate content and features to be included with activity bar as tile elements 117₁₋ₙ and present activity bar as a horizontal deck of elements in horizontal region 111. Horizontal region 111 allows for left and right directional commands to navigate to and within components of control interface 110.

Profiles 125₁₋ₙ relate to one user profiles stored by a display device for control interface 100. In one embodiment, profiles 125₁₋ₙ are utilized to determining display format of the personal dashboard component 110. According to another embodiment, one or more elements of launcher component 105 and activity strip 115 may be presented base on an active profile of profiles 125₁₋ₙ. When a profile has not been selected, an active profile may be the last selected or utilized user profile.

According to another embodiment, components of control interface 100 may be selected, navigated and updated based on user interactions with a display device and one or more inputs from a remote control. According to one embodiment, elements of control interface 100 are presented by display device 130, such as digital television, as part of control interface 120.

Presentation of control interface 100 may be in response to a command from remote control, such as selection of a home or menu key. According to another embodiment, control interface 100 may be displayed shortly after a power on of display device 130. According to another embodiment control interface 100 may be presented following presentation of a wake animation and prior to display of a sleep or shutdown animation.

From control interface 100, several features and functions of a display device may be provided by ordered combinations of display device operation and graphical elements presented by the display device.

Launcher

According to one embodiment, launcher component 105 is configured to allow for a user to access content and control features of the display device. In one embodiment, launcher component includes a launcher bar 106, primary area 107 and secondary area 108. Launcher bar 106 may related to a plurality of tab elements arranged in a horizontal strip, wherein selection by moving a highlight element of the display device to a tab element will update the presentation elements of the launcher. By way of example, launcher bar 105 may include a tab for broadcast channels, video on demand and display device settings. Primary area 107 may include presentation of tile elements below the launcher bar 106. Tile elements of primary area 107 may be selected by the display device as the most relevant content of features associated with a selected tab element. Secondary area 108 may be presented below the primary area with additional tiles associated with content and/or display device function. Secondary area 108 may allow for additional selectable elements. According to one embodiment, the display format of launcher bar 106, primary area 107, and secondary area 108 may be based on the presentation status of the control interface. For example, launcher component may be presented initially with launcher bar 106, then commands to expand launcher component (e.g., a directional command) can result in display device updating the display output to include one or more tile elements of the primary area. Tile elements of the secondary area 108 may be presented based on additional navigation within the launcher component.

According to one embodiment, an initial format, such as a home screen presentation, of control interface 100 includes presentation of launcher bar, and a row of tile elements of the primary area. Based on a user input to select and/or navigate within launcher component 105, additional formats may be presented such as an increase in presentation footprint of the launcher to allow for secondary area 108 to include additional rows of tile elements. According to another embodiment, the primary area 107 and secondary area 108 of launcher component 105 may also include a first section for presentation of a most relevant tile element, and a second section for presentation of other tile elements along a horizontal display plane.

According to one embodiment, control interface 100 provides launcher component 105 as an overlay control interface to allow for presentation of content and control features based on selection of launcher tabs and navigation within the launcher component. In one embodiment, the configuration of launcher component 105 is a progression away from traditional desktop menus and allows for simple directional commands to access TV, network, applications, recommendations, personalized configurations, and recent content. According to another embodiment, launcher bar 106 of launcher component 105 includes a plurality of tab or tile elements, wherein each tab allows for a selection of a particular type of content, source of content, and/or control features of a display device. Based on the selection of a tab element of launch bar 106, launcher component may present multiple rows of content/element tiles and allows for scrolling to additional rows within a display window to provide and extended content region. In one embodiment, each row of content tiles may be navigated to based on vertical directional commands (e.g., up/down) and rows of content tiles may be navigated with horizontal directional commands (e.g., left/right). The presentation order of rows and even tiles in each row may be based on one or more of a selected user profile, content presented prior to display of control interface 100 and relevance determinations. In additional to content, such as video and programming information, tiles presented in launcher component 105 may relate to one or more of applications, settings, smart home applications, education/learning applications, gaming, etc.

Launcher Search

According to one embodiment, control interface 100 may include a search functionality component including a graphical interface for searching content titles, applications and elements of launcher component 105. In one embodiment, the search functionality may be presented as a drop down (e.g., down sliding transition) interface from an intermediary presentation format of control interface 100. According to another embodiment, the search functionality can interact with other devices (e.g., mobile devices) with a display device hosting a network interface for entry of search queries. Features of the search functionality can include one or more of a text entry box, alpha numeric display, recent search listing and suggested search results.

Personal Dashboard

According to one embodiment, control interface 100 includes dashboard component 110 to provide a user customizable control interface for a portion of the control features. In one embodiment, dashboard component 110 provides graphical elements for selecting and modifying display attributes and functionality of the dashboard. According to another embodiment, dashboard component can allow for a graphical selection of user profiles that can define features of control interface 100.

According to one embodiment, personal dashboard component 110 allows for presentation of a personalized control interface associated with a user profile. By way of example, display device is configured to allow a user to personalize the display format of the user interface to select display attributes such as a wallpaper, avatar, etc. In that fashion, dashboard component 110 allows for presentation of a personalized control interface. According to one embodiment, control interface 100 can allow for presentation of several user profiles 125₁₋ₙ. Selection of the profile may be performed during navigation to personal dashboard component 110 within control interface 100. According to one embodiment, the initial display presentation format of personal dashboard component 110 relates to a tile element, such as a screen capture of the personal dashboard. When an intermediate display configuration of control interface 100 is provided, the same tile representing personal dashboard component 110 may be reformatted. According to one embodiment, personal dashboard component 110 may be displayed adjacent to activity bar 115 in a horizontal region 111 of the display.

In one embodiment, dashboard component 110 provides a display interface to include notifications and access to applications which may be run by a display device. According to another embodiment, dashboard component 110 allows for personalization such as one or more of wake/sleep animations, screensavers, audio themes, badges and gaming. Dashboard component 110 allows for a customizable interface within the overall control interface 100 of a display device.

Touch Interface

Presentation of elements within control interface can include one or more display formats and format changes. In certain embodiments, presentation of elements introduces similarities of touch commands to a display device operated from a distance without actual contact to the display. According to one embodiment, control interface 100 can update presentation of display elements such as tiles to gradually reveal content. According to one embodiment, control interface 100 can receive inputs based on a capacitive touch sensor with gradual display of elements, but also allowing for accidental touches. Capacitive interaction can provide a control feature with a level of touch control for a display device that is normally operated/viewed from a distance. Control interface 100 may be configured with an interaction to model tactile representation for interaction with elements based on a capacitive/interactive remote control. In one embodiment, interaction may include progressive disclosure of content, a multilayered preview into content and instant access to recommendation.

Contextual Touch

According to one embodiment, elements of control interface 100 can support presentation of tile elements as overlay to content without presentation of the full control interface. By way of example, a display device may be configured to recognize a category or genre of actively displayed content and present a display of similar programs to avoid the need to access a display menu and searching of content.

Instant Companion Application and Search

According to one embodiment, control interface 100 can allow for control of a display device by a mobile device and to allow for presentation of graphical display elements of control interface 100 to be displayed by a mobile device. In one embodiment, control interface 100 may host temporary access between a display device and another web enabled device. According to another embodiment, devices may be paired based on displayed elements that may be detected by the web enabled device. Thus, control interface 100 may be configured for pairing/connection with a user interface, such as a personalized user dashboard for display devices and search functions within the launcher control interface. According to certain embodiments, interaction of a mobile device with control 100 does not require a user to download a specific application to establishing the temporary network connection for interaction and control of a display device.

Smart Sense Recommendations

According to one embodiment, control interface 100 can utilize one or more processes for populating content elements within launcher component 105. According to one embodiment, control interface 100 may be presented based on processes for tracking and identifying content for recommendation within the launcher component. For example, content tiles may be arranged in groupings such that groupings with the highest contextual relevance priority are arranged towards the top of launcher component 105.

Conversense

According to one embodiment, control interface 100 and elements of control interface 100 can be utilized by a display device to present a display configured tailored to startup of the display device with information and display elements having high relevance. In one embodiment, elements of the startup display may be selected and presented based on a recognized time of day, personal settings and history.

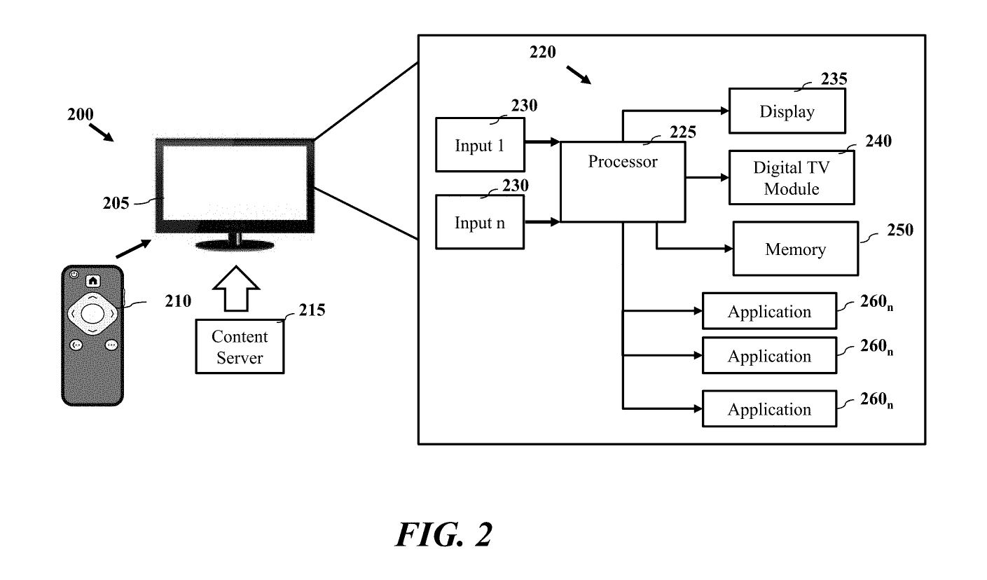

FIG. 2 depicts a simplified system diagram according to one or more embodiments. System 200 includes display device 205 and remote control 210. Remote control 210 may be configured to provide commands for interaction with and control of display device 205 relative to a control interface (e.g., control interface 100) presented by display device 205. Content, applications and other network services may be provided to display device 205 by way of one or more content servers, such as content server 215.

Digital television 200 includes processor 225, inputs 230, display 235, digital TV module 240, memory 250, and applications 260₁₋ₙ. It should be appreciated that digital television 205 may include one or more additional components not shown in FIG. 2. Digital television 205 is configured to present a control interface as described herein.

Inputs 230 relate to physical inputs for receiving video/image content and/or network data for presentation of content on display 235. Digital TV module 240 includes decoder/converter elements to receive information and content from inputs 230 which is then formatted and output to processor 225 for presentation on display 235. Memory 250 may include ROM and RAM memory for operation of digital television 205 and processor 225.

Processor 225, in addition to controlling operation of a digital television, is configured to control presentation and operation of a control interface. According to one embodiment, processor 225 is configured to detect commands for presentation of a control interface for the digital television, present the control interface including an expanded tab element and a plurality of tab elements. Processor 225 may also detect second or additional commands for the control interface to select one of the plurality of tab elements and update presentation of the control interface in response to the commands.

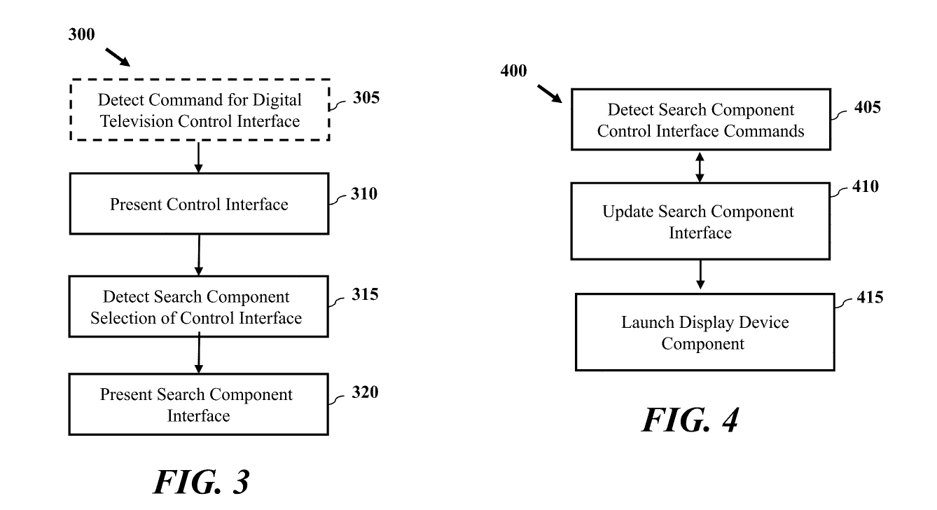

FIG. 3 depicts a process for device operation including presentation of a control interface according to one or more other embodiments. Process 300 may be employed by a device (e.g., display device 205) to provide a control interface, and in particular, presentation and updating of the control interface in response to received commands. According to one embodiment, process 300 is performed by a processor (e.g., processor 225) based on instructions stored in non-transitory memory 250. According to yet another embodiment, processor 300 is configured to present a search component interface.

Process 300 may optionally include detecting a command for presentation of a control interface at block 305. In one embodiment a display device (e.g., display device 205) receives a command from a remote control (e.g., remote control 210) to display the control interface. Detection of a first command for presentation of a control interface for the display device at block 305 may be based on selection of a menu or home key on the remote control. In certain embodiments, detection of a first command at block 305 is in response to a mobile device pairing the display device and/or launch of an application on the mobile device to operate the display device. At block 310, the display device presents the control interface.

Detection of a command at block 305 is optional in process 300 as a display device may present a control interface during use without requiring detection of a control command. For example, the display device may present a control interface at block 310 during a wake up process of the display device. In other embodiments, the display device may present the control interface at block 310 following viewing of content, connection of an external device, inadvertent button presses on a remote, pairing of a mobile device, etc.

According to one embodiment, a control interface is presented at block 310 according to a spatial arrangement model and including interface components. As will be discussed in more detail below, a spatial arrangement model defines the arrangement of each of the launcher component, dashboard component and activity strip relative to one another in the control interface. According to another embodiment, the spatial arrangement model provides a plurality of display presentation formats for each of the launcher component, dashboard component and activity strip to provide navigation within each component and control of the display device. In one embodiment, the spatial arrangement model is characterized by a cross shape layout which each of the launcher component, dashboard component, activity strip and search component are positioned at a terminus of the cross shape. The cross shape may represent direction commands of up, down, left and right for an input device to the display device. In one embodiment, the graphical search element is positioned in a top portion of the control interface. As such, a directional command associated with the display position (e.g., up for top) of the graphical element indicating a search component is an up command.

In block 310, the control interface is presented to include graphical presentations of a launcher component, dashboard component and activity strip according to display positions and formats of the spatial arrangement model, and a graphical search element indicating a search component of the control interface. The launcher component is configured for selection and presentation of content. In one embodiment, the launcher component includes a tab bar having a plurality of tab elements, a primary region and a secondary region, wherein the primary region and secondary region are presented to include a plurality of content tiles based on a selected tab of the tab bar. The dashboard component presents a personalized interface based on one or more user profiles. In one embodiment, the personal dashboard component includes a control interface within at least one of a background, avatar, welcome message, widget and content strip based on a selected user profile. The activity strip is configured to present a plurality of tile elements for selected content. In one embodiment, the activity strip includes a plurality of graphical display tiles, wherein each tile is arranged in a horizontal strip to provide selected content based on activity detected with the display device. The graphical search element includes an icon or display element to indicate a search functionality, such as a magnifying glass, the word search or other element.

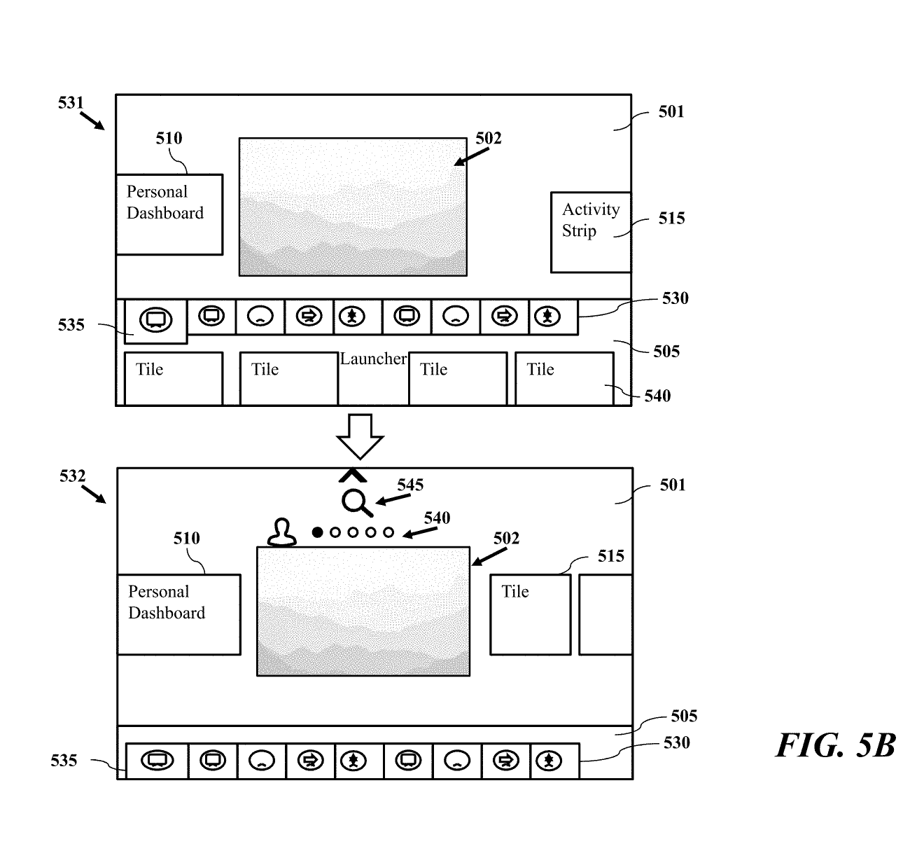

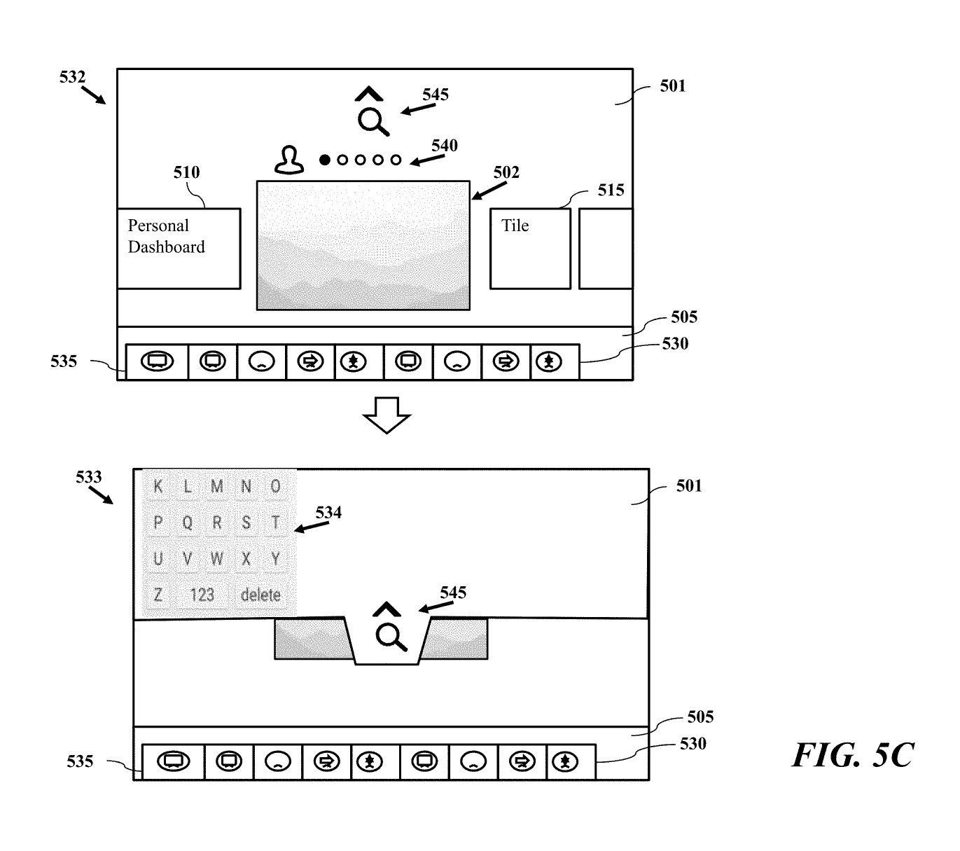

According to one embodiment, the control interface does not have a single presentation view, but rather, several levels of views. As such, the presentation size of each component and the amount of area that each component occupies may be modified and updated by the display device to provide a visual interface for control of the display device. Updating the presentation format allows for many different features to be accessed based on navigation with the spatial arrangement model. In one embodiment, presentation of the control interface at block 310 is in response to first command and includes presentation of a first format for the launcher component, a first format for the dashboard component and a first format for activity strip each, wherein a first format of components includes a display format of reduced size and functionality for each component. A first format for display of the control interface according to an exemplary embodiment is shown in FIG. 5B.

At block 315, the display device detects a directional command associated with the display position of the graphical search element. In one embodiment, the directional command detected at block 315 is an up command generated by a direction pad or input of a remote control device. Directional commands detected at block 315 may also include swipe or motion commands generated by a remote control device.

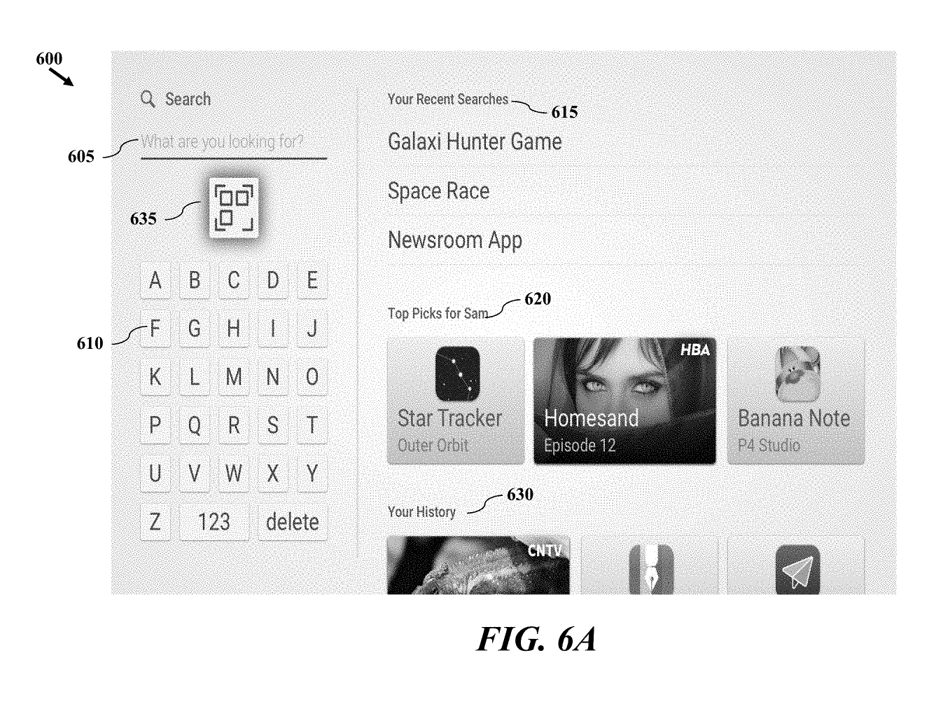

At block 320, the display device updates presentation of the control interface to present a graphical representation of the search component. The search component is presented to provide an interface and search function for each of the launcher component, dashboard component and activity strip. A graphical representation of a search component is depicted in FIGS. 6A-6B. In one embodiment, presentation of the of a graphical representation of the search component includes a transition from the control interface format/representation to that of the graphical search element appearing to drop/slide away from the current display position (e.g., a top position) and result in an animation of the graphical search element sliding to present graphical elements of the search component. According to another embodiment, presentation of the search component at block 320 can include display of an optical target to provide a secondary device with a temporary connection to the display device.

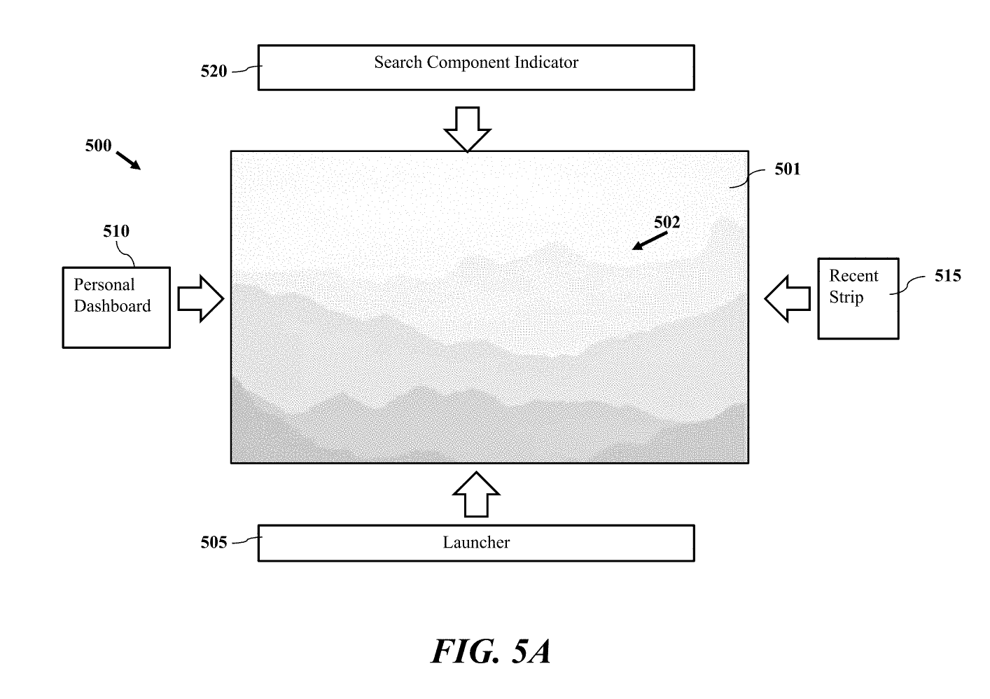

FIG. 4 depicts a process for presentation of a search component control interface according to one or more embodiments. Process 400 represents a flow for presentation and navigation of a search component control interface. According to one embodiment, process 400 includes detecting commands of a search component control interface at block 405. According to one embodiment, commands detected at block 405 can relate to selection one or more sections of the search component interface. Display sections of the search component may relate to features of the search component. According to one embodiment, commands detected at block 405 can include one or more of character selection, initiation of search based on selected characters, navigation and selection of items listed in a recent search list and selection of content tiles included in the search component. In certain embodiments, and as discussed in more detail below, detection of search component control interface commands may be generated by a secondary device.

In response to one or more commands for the search component interface, process 400 includes updating the search component interface at block 410. Updating the search component interface at block 410 includes identifying elements of the control interface based on search input. In addition, updating the search component interface can include determining which elements of the control interface to search. The search component can search control interface components based on one or more of content, applications, and titles of the components/settings. In one embodiment, selection of one or more characters can result in display of a list of content titles or control interface components that match or include searched characters. According to another embodiment, the search component updates as characters are selected. According to another embodiment, updating at block 410 can include changing position of a highlight or selection element based on navigation commands detected at block 405. At block 410, process 400 may also include the display device determining which components of elements of the control interface to search based on selected characters or queries.

Control interface commands detected at block 405 can also include selections of search results. In response, process 400 includes launching one or more of display device content, applications and control settings of the display device based on a selection at block 415. Process 400 can also include launching a display device component (e.g., launcher component, dashboard component, etc.) at block 415.

FIG. 5A depicts a graphical representation of control interface components and a spatial arrangement model according to one or more embodiments. According to one embodiment, a spatial arrangement model 500 provides a layout or arrangement of control interface components. According to one embodiment, spatial arrangement model 500 is a cross shaped model having a launcher component 505 associated with the bottom terminus of the cross, personal dashboard component 510 associated with the left terminus of the cross, activity strip component 515 associated with the right terminus of the cross, and a search component 520 with the top position of the cross. In that fashion, the spatial arrangement model provides a roadmap to navigating to component features of the display device. According to another embodiment, spatial arrangement model may include additional terminal ends for other components (not shown in FIG. 5A).

Spatial arrangement model 500 is depicted relative to display 501 including content 502. Based on a command to present the control interface, components 505, 510, 515 and 520 may transition as overlays to content 502 to present the initial display format of the control interface. A graphical representation of the initial presentation format is depicted as 531 in FIG. 5B. Based on one or more additional commands, the display format of components 505, 510, 515 and 520 may be updated.

FIGS. 5B-5C depict graphical representations of control interface display formats according to one or more embodiments for components 505, 510, 515 and 520 of FIG. 5A.

FIG. 5B depicts initial presentation format 531 including components 505, 510 and 515. Components 505, 510 and 515 are presented relative to display 501. As shown in FIG. 5B, content 502 is presented as a reduced size tile of still or video image of the last input to display 501. Display content 502 may be a screen shot of the content when a control interface command is received. Launcher component 505 includes tab bar 530 with highlight 535 on the leftmost tab. A primary display area 540 of launcher component includes a plurality of tiles each associated with content based on the tab with highlight 535.

According to one embodiment, from initial format 531 the display device presents display format 532. Display format 532 may represent an intermediate format of the control interface. According to one embodiment, from initial format 531 the display device presents display format 532 which may be based on an up command. As such, the control interface still presents components 505, 510, 515 and 520 in addition to display content 502; however, the presentation format of launcher 505 is modified with reduced size. In display format 532, personal dashboard component 510 may be presented with an increased size and content tiles of the activity strip 515 are shown. According to one embodiment, format 503 includes a status bar 545 indicated the position of the highlight with respect to the dashboard component and activity strip component.

In format 532, the focus may be on display content 502. In that fashion a user can select display content 521 to return to the content. Alternatively, an up command will select graphical search element 545.

FIG. 5C depicts initial presentation format 532 transitioning to search component format 533 which is partially shown. In display format 533, the search component transitions the control interface presentation with elements of the search component, such as a character display 534 appearing in the display window. Graphical search element 545 indicates a drop down search function tied to components of the display device. Graphical search element 545 is displayed as a search icon that provides a target and/or directional hint. The graphical search element 545 slides down and transitions over the elements of 532 revealing the search component presentation.

FIGS. 6A-6B depict graphical representations of a search component interface according to one or more embodiments. Referring first to FIG. 6A, a search component format 600 is presented to include search input 605, character selection element 610, recent searches listing 615, recommendations 620 and partial display of previous selections, shown as history elements 630. Display format 600 may relate to an initial presentation of the search component as a control interface. According to one embodiment, each element in the search component, e.g., search input 605, character selection element 610, recent searches listing 615, recommendations 620, can be navigated to and within so that searches can be performed by the display device. Search input 605 allows for characters selected using character selection element 610 to be input as a search query. Search input 605 displays character selections as they are made. In certain embodiment, search input 605 appends character selections based on matching or likely search results. Recent searches listing 615 provides a listing of pretentious searches and may list one or more previous search queries. A search component may also include one or more strips of graphical elements including a recommendations listing 620, history listing 630.

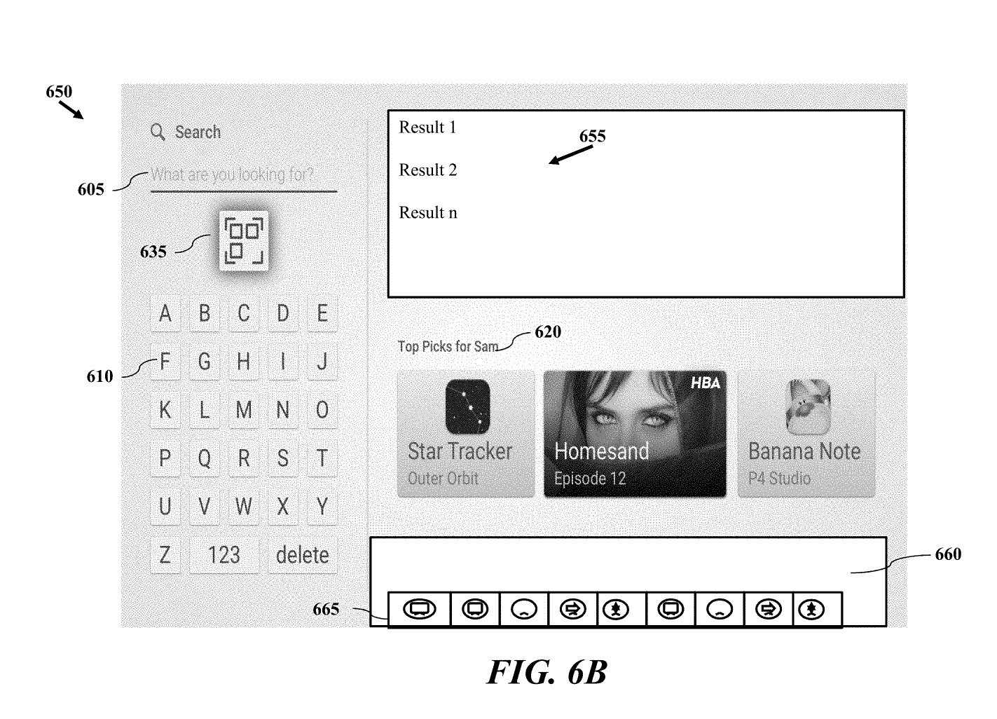

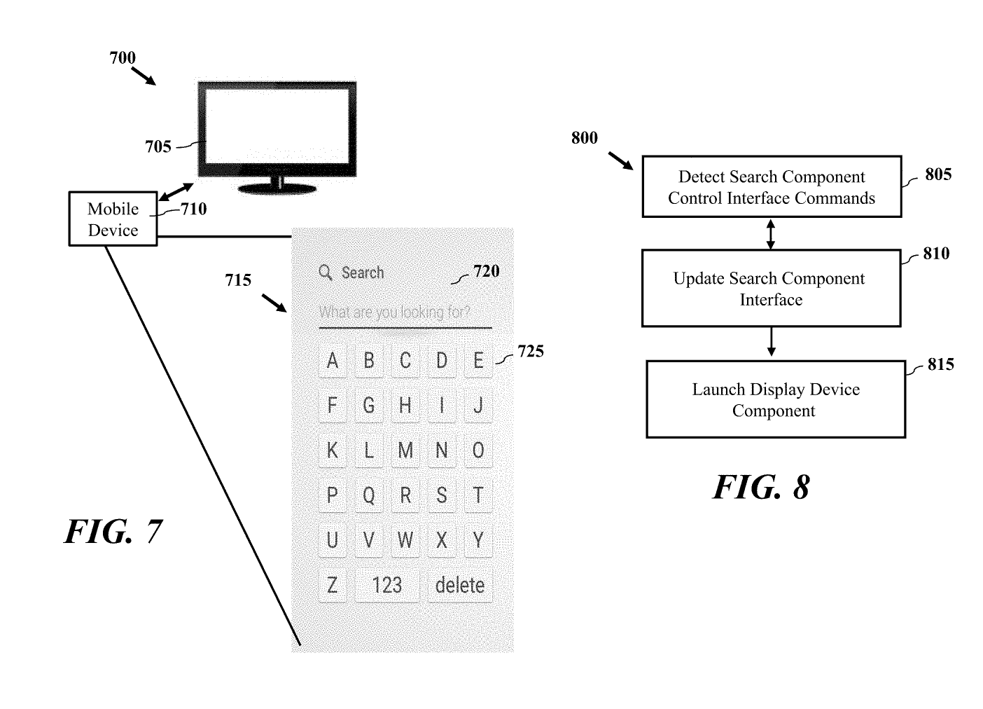

According to another embodiment, search component 600 may be presented to include optical target 635. The search component may provide optical target 635 to be scanned by a secondary device (e.g., mobile device, etc.). Scanning of optical target 635 allows for a display device to provide a local network address for the secondary device and an interface for a temporary network connection. As will be discussed in FIGS. 7 and 8, the secondary device can display elements of the search component, and provide search inputs to the display device.

FIG. 6B depicts a graphical representation of the search component format 650 including one or more search results, in results listing 655. In certain embodiments, the search component may also present a graphical representation of control interface components. Format 650 includes a lower bar format of a launcher component 660 including a bar of elements 665. Elements of launcher component 660 including a bar of elements 665 may be based on inputs to search input 605.

FIG. 7 depicts a graphical representation of a search component operation according to one or more embodiments. According to one embodiment, FIG. 7 depicts system 700 including display device 705 and a secondary device, such as mobile device 710. Interaction of display device 705 and mobile device 710 allow for the mobile device to present graphical elements of the search component (e.g., search component format 600) on a display of the mobile device. By way of example, mobile device 710 may display a search component format 715 including search input 720 and character selection element 725. According to one embodiment, display device 705 provides a temporary network control interface based on detection of scanning of the optical target by mobile device 710.

FIG. 8 depicts a process for search component operation according to one or more embodiments. Process 800 may be initiated by a display device detecting search component control interface commands at block 805 by a display device (e.g., display device 705). Commands detected at block 805 may be generated by a secondary device (e.g., mobile device 710) by way of a temporary network control interface based on detection of scanning of the optical target by the secondary device. Thus, commands at block 805 may relate to a search component presented by the display device and can include control from the secondary device for the search component.

At block 810, the display device updates presentation of the search component based on commands detected at block 805. The display device can launch content based on selections at block 815. Again, selections may be generated by a mobile device using the search component provided by the temporary network control interface. Once selection and use of the search component is completed the display device may terminate the temporary network control interface. Control interface presentation as discussed herein provide a visual layout that allows for directional commands to access the search component and thus, search, a display device interface and content. In addition to display configurations and particular control elements, processes and device configurations are provided to allow for a secondary device to interoperate with the search component of a control interface.

While this disclosure has been particularly shown and described with references to exemplary embodiments thereof, it will be understood by those skilled in the art that various changes in form and details may be made therein without departing from the scope of the claimed embodiments.

What is claimed is:

1. A method for display device operation including presentation of a control interface search component, the method comprising:
presenting, by the display device, a control interface according to a spatial arrangement model and including interface components, wherein the control interface is presented to include
graphical presentations of a launcher component, dashboard component and activity strip according to display positions and formats of the spatial arrangement model, and
a graphical search element indicating a search component of the control interface;
detecting, by the display device, a directional command associated with the display position of the graphical search element; and
updating, by the display device, presentation of the control interface to present a graphical representation of the search component, the search component providing an interface and search function for each of the launcher component, dashboard component and activity strip.

2. The method of claim 1, wherein the spatial arrangement model defines the arrangement of each of the launcher component, dashboard component, activity strip and graphical search element.

3. The method of claim 1, wherein the spatial arrangement model includes a cross shape layout wherein each of the launcher component, dashboard component activity strip and graphical search element are positioned at a terminus of the cross shape layout.

4. The method of claim 1, wherein the graphical search element is positioned in a top portion of the control interface, and wherein the directional command associated with the display position of the graphical element indicating a search component is an up command.

5. The method of claim 1, wherein the control interface includes
a graphical presentation of a launcher component, the launcher component configured for selection and presentation of content,
a graphical presentation of a dashboard component, the dashboard component configured to present a personalized interface based on a user profile, and
a graphical presentation of an activity strip, the activity strip configured to present a plurality of tile elements for selected content;

6. The method of claim 1, wherein updating presentation of the control interface to present the graphical representation of the search component includes transition of the graphical search element from a top position by way of a drop down animation and presentation of graphical elements of the search component.

7. The method of claim 1, wherein updating presentation of the control interface to present the graphical representation of the search component includes display of
a character input display,
search entry, and
listing of recent searches.

8. The method of claim 1, wherein presentation of the search component includes display of an optical target to provide a secondary device with a temporary connection to the display device.

9. The method of claim 1, further comprising generating a temporary network control interface based on detection of scanning of the optical target by the secondary device, wherein the search component is provided to the secondary device by way of the temporary network control interface.

10. The method of claim 1, wherein the search component searches control interface components based on one or more of content, applications and titles of the components.

11. A digital television comprising:
a display configured to present a control interface; and
a processor coupled to the display, the processor configured to
detect a first command for presentation of a control interface for the display device;
present a control interface according to a spatial arrangement model and including interface components, wherein the control interface is presented to include
a graphical presentation of a launcher component, the launcher component configured for selection and presentation of content,
a graphical presentation of a dashboard component, the dashboard component configured to present a personalized interface based on a user profile, and
a graphical presentation of an activity strip, the activity strip configured to present a plurality of tile elements for selected content;
detect a command for navigation relative to the control interface; and
update presentation of the control interface to present an intermediate display format for the control interface, wherein each of the launcher component, dashboard component and activity strip are accessible for selection during presentation of the intermediate display format.

12. The device of claim 11, wherein the first command is received by the display device from a remote control device.

13. A digital television comprising:
a display configured to present a control interface; and
a processor coupled to the display, the processor configured to
present a control interface according to a spatial arrangement model and including interface components, wherein the control interface is presented to include
graphical presentations of a launcher component, dashboard component and activity strip according to display positions and formats of the spatial arrangement model, and
a graphical search element indicating a search component of the control interface;
detect a directional command associated with the display position of the graphical search element; and
update presentation of the control interface to present a graphical representation of the search component, the search component providing an interface and search function for each of the launcher component, dashboard component and activity strip.

14. The device of claim 11, wherein the spatial arrangement model includes a cross shape layout wherein each of the launcher component, dashboard component activity strip and graphical search element are positioned at a terminus of the cross shape layout.

15. The device of claim 11, wherein the graphical search element is positioned in a top portion of the control interface, and wherein the directional command associated with the display position of the graphical element indicating a search component is an up command.

16. The device of claim 11, wherein the control interface includes
a graphical presentation of a launcher component, the launcher component configured for selection and presentation of content,
a graphical presentation of a dashboard component, the dashboard component configured to present a personalized interface based on a user profile, and
a graphical presentation of an activity strip, the activity strip configured to present a plurality of tile elements for selected content;

17. The device of claim 11, wherein updating presentation of the control interface to present the graphical representation of the search component includes transition of the graphical search element from a top position by way of a drop down animation and presentation of graphical elements of the search component.

18. The device of claim 11, wherein updating presentation of the control interface to present the graphical representation of the search component includes display of
a character input display,
search entry, and
listing of recent searches.

19. The device of claim 11, wherein presentation of the search component includes display of an optical target to provide a secondary device with a temporary connection to the display device.

20. The device of claim 11, further comprising generating a temporary network control interface based on detection of scanning of the optical target by the secondary device, wherein the search component is provided to the secondary device by way of the temporary network control interface.

21. The device of claim 11, wherein the search component searches control interface components based on one or more of content, applications and titles of the components.
